(19) United States
(12) Patent Application Publication
(10) Pub. No.: US 2016/0116574 A1
(43) Pub. Date: Apr. 28, 2016

(54) GROUND-BASED GEO-REFERENCED INTERFEROMETRIC RADAR

(71) Applicant: REUTECH RADAR SYSTEMS (PROPRIETARY) LIMITED, Stellenbosch (ZA)

(72) Inventors: Anton Francois Joubert, Cape Town (ZA); Cornelius Jacobus Adriaan Nel, Cape Town (ZA)

(21) Appl. No.: 14/895,607

(22) PCT Filed: May 5, 2014
(86) PCT No.: PCT/IB2014/061208

§ 371 Date: Dec. 3, 2015

(30) Foreign Application Priority Data
Jun. 6, 2013 (ZA) 2013/04144

(51) Int. Cl. G01S 7/40

(52) U.S. Cl. CPC G01S 7/4026; G01S 2007/403; G01S 2007/4034

(57) ABSTRACT

A system and method for geo-referencing a main measuring instrument which operates in an Instrument Coordinate System. The method includes the steps of deploying the main measuring instrument on a deployment surface. An auxiliary measuring instrument is used to measure the position of a plurality of external reference points in a Master Coordinate System as well as a plurality of local reference points on the main measuring instrument in the Master Coordinate System. An inclinometer associated with the main measuring instrument, obtains an orientation reading for the deployed main measuring instrument. A processor then uses the orientation reading and the measured positions of the external reference points and the local reference points on the main measuring instrument, to geo-reference the main measuring instrument so that measurements made therewith are automatically output in the Master Coordinate System.

### BACKGROUND OF THE INVENTION

This invention relates, in a first aspect, to geo-referencing of an instrument relative to a master coordinate system. The instrument may be, in particular, a ground-based interferometric radar system. The invention further relates to such a radar system and to a method of operation thereof.

Such radar systems are used in open pit mines to monitor the stability of exposed slopes or pit walls. The radar transmits radio waves to the face of a slope and receives echoes of the transmissions. The transmissions happen in a predetermined scan pattern that covers a large area of the pit wall. The radar compares data from consecutive scans to determine if there was any slope movement between scans and, if so, how much. All measured movement is accumulated over time. Depending on the atmospheric conditions the accuracy of this data is sub-millimeter. This information is then used to alert mine personnel of any threatening slope failure so that the necessary precautions can be taken.

Existing radar systems of this kind are effective but it can be difficult and time consuming to set them up for accurate operation, particularly with regard to geo-referencing of the systems.

The Master Coordinate System (MCS) is defined with respect to the earth, typically Local Level, Local North, Earth Centered or any other suitable definition. The typical procedure for geo-referencing is:
a) Level the instrument/system with respect to the local gravity vector;
b) Select at least three, preferably four, reference points in the MCS. The MCS coordinates of these points are known;
c) Measure the 3D position or azimuth and elevation angles of these reference points in the Instrument Coordinate System (ICS); and
d) Determine the heading angle of the ICS within the MCS.

Using the information above the ICS is completely defined within the MCS. Although the requirement (a) above simplifies any applicable geo-referencing algorithm substantially, it requires hardware to implement the leveling function and in cases of steep gradients the travel provided by the hardware may not be sufficient. In addition the leveling takes time and if not performed with sufficient accuracy will compromise the data supplied to such a degree that it can be a safety hazard, particularly in the applications where pit wall movement of open pit mines are measured and reported in the MCS.

It is an object of the invention to provide a radar system which is easier and quicker to set up without any limitations on the gradient of the surface of deployment.

### SUMMARY OF THE INVENTION

According to a first aspect of the invention there is provided a method of geo-referencing a main measuring instrument which operates in an Instrument Coordinate System, the method including the steps of:
deploying the main measuring instrument on a deployment surface;
using an auxiliary measuring instrument, measuring the position of a plurality of external reference points in a Master Coordinate System;
using the auxiliary measuring instrument, measuring the position of a plurality of local reference points on the main measuring instrument in the Master Coordinate System;
using an inclinometer associated with the main measuring instrument, automatically obtaining an orientation reading for the deployed main measuring instrument;
entering the measured positions of the external reference points and the local reference points on the main measuring instrument into a processor of the main measuring instrument; and
using the orientation reading and the measured positions of the external reference points and the local reference points on the main measuring instrument, automatically geo-referencing the main measuring instrument so that measurements made therewith are automatically output in the Master Coordinate System.

According to a second aspect of the invention there is provided a measuring instrument system including:
a main measuring instrument which operates in an Instrument Coordinate System for monitoring at least one parameter of an environment in which it is deployed;
a support structure for deploying the main measuring instrument on a deployment surface;
an inclinometer associated with the main measuring instrument, for automatically obtaining an orientation reading for the deployed main measuring instrument;
a processor arranged to receive measured positions of a plurality of external reference points in a Master Coordinate System, measured positions of a plurality of local reference points on the measuring instrument in the Master Coordinate System, and an orientation reading from the inclinometer, and automatically to geo-reference the main measuring instrument so that measurements made therewith are automatically output in the Master Coordinate System; and
at least one output interface for outputting data representative of measurements made by the main measuring instrument.

The main measuring instrument may be, in an example embodiment, a radar or laser operable to monitor the stability of a slope, to detect slope movement and to generate an alert if movement is detected.

In an example embodiment, the main measuring instrument is a ground-based radar with an antenna mounted on a housing, the local reference points being on or adjacent the housing.

Preferably the inclinometer is mounted on a support member of the antenna which is fixed relative to the housing, the antenna being movable in azimuth and elevation relative to the support member.

The processor is preferably arranged to receive inputs from the antenna, and further inputs via a human/machine interface obtained from an auxiliary measuring instrument during a set-up phase of operation.

The principles of the invention will apply to any instrument that is required to report its measurements in a Master Coordinate System (MCS) and where the orientation of the instrument is important to establish the relationship between the MCS and an Instrument Coordinate System (ICS).

### BRIEF DESCRIPTION OF THE DRAWINGS

FIG. 1 is a schematic diagram showing an example embodiment of a ground-based interferometric radar system of the invention deployed in an open-pit mine;

FIG. 2 is a perspective view showing the ground-based interferometric radar system of FIG. 1 in greater detail;

FIG. 3 is a schematic block diagram showing major components of the radar system;

FIG. 4 is a processing block diagram illustrating the processing necessary for deployment of the radar system; and

FIG. 5 is a processing block diagram similar to that of FIG. 4, illustrating the processing necessary for operation of the radar system after a scan has been initiated.

### DESCRIPTION OF A PREFERRED EMBODIMENT

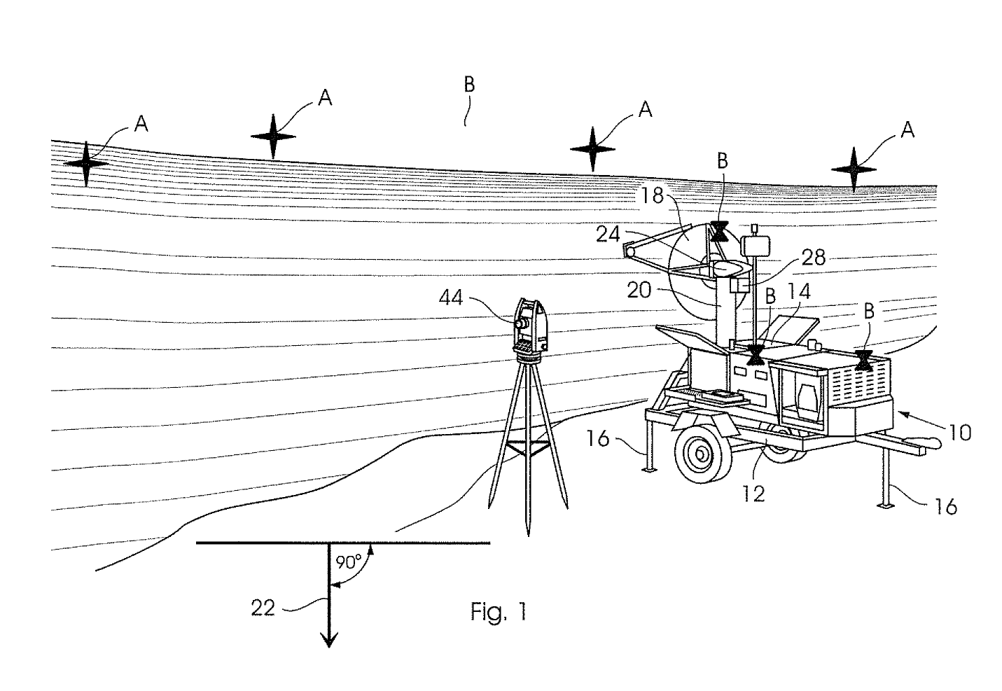

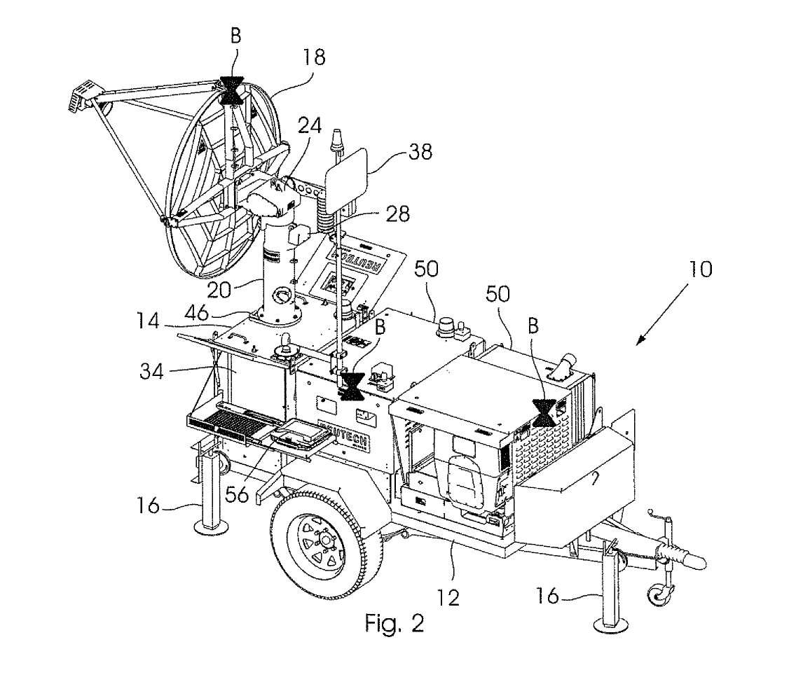

FIG. 1 shows an example embodiment of a radar system of the invention deployed in an open-pit or open-cast mine. The radar system itself is shown in more detail in FIG. 2.

The radar system 10 is built as a mobile unit on a wheeled trailer 12 which can be towed behind a vehicle and deployed where needed. The trailer 12 carries a main housing 14 which contains the bulk of the electronic components of the system, and includes three stabilizing legs 16 (one at the front end of the trailer adjacent the tow hitch and two spaced apart at the rear of the trailer).

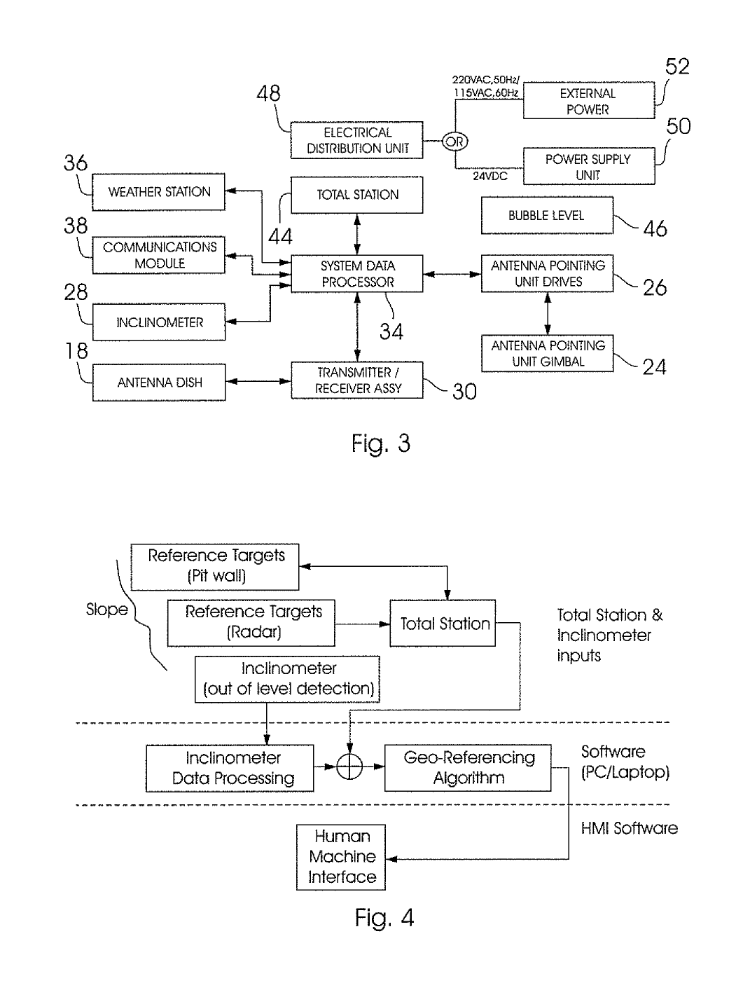

The main components of the radar system are also shown schematically in the block diagram of FIG. 3.

An antenna dish 18 is mounted on an antenna pointing unit which comprises a pillar 20 carrying a gimbal mount 24. The antenna pointing unit includes drives and actuators 26 to move the antenna in azimuth and elevation as well as providing a mounting for an inclinometer 28. The inclinometer is arranged on the pillar 20 to detect orientation of the radar system with respect to the local gravity vector 22. The inclinometer is a two-axis instrument, measuring two angles with respect to the local gravity vector

The system further includes the following components:

30: Transmitter/Receiver Assembly. These components generate the radio frequency transmission signal which is fed to the antenna 18 and receive the echo signal from the antenna. (These components form the transceiver of the system.)
34: System Data Processing module. This module commands and controls the system and does all the data processing.
36: Weather station. This unit provides atmospheric data that the System Data Processor uses to improve the system's measurements.
38: Communications Module. This unit relays the system health-status and any other selected data to a control room anywhere on the globe where this information may be needed.
44: Total Station. This station comprises survey equipment for deployment of the system, by means of the measurement of reference targets on, or around, the pit wall and the radar itself.
46: Bubble Level. This is a component mounted on the housing of the radar system to indicate whether the radar is aligned with the local gravity vector or not (this reading is taken by the operator and not electronically integrated with the system).
48: Electrical Distribution Unit. This unit distributes power at the required levels to the various electrical and electronic components of the system.
50: Power Supply Unit. This is the radar system's own power supply unit, which will be used if no external power is available. Alternatively, where an External Power Source 52 is available, this can be used to run the system.
56: Human-machine interface. This can be a ruggedized laptop computer, as illustrated, and/or a display and keyboard (or other input device) built in to the housing 14.

In order to get the system operational, it is necessary first to deploy the system so that it is stable, such that it would not interfere with the accuracy of measurements of the system. This step includes geo-referencing of the radar (see below). It is then necessary to set up the scan areas, scan speed, reference area(s) and alarm parameters. Once this has been done, a scan can be initiated.

The processing block diagram of FIG. 4 depicts the processing necessary for deployment of the radar system, while the similar diagram of FIG. 6 depicts the processing necessary for operation of the radar system after a scan has been initiated.

In order to geo-reference a known prior art radar system of this general kind, it was necessary to level the radar with respect to the local gravity vector. This was done using a bubble level, which had to be read by a user. If the radar was not level, leveling legs were used to adjust the orientation of the radar until the bubble level gave a level reading. The detailed steps are listed in Table 1 below, which compares the operation of the radar system of the invention with the prior art system.

TABLE 1

| STEP | DESCRIPTION | REQUIREMENTS | PRIOR ART | NEW |
|---|---|---|---|---|
| 1 | Level system wrt local | Surface must be level | YES (step | NO (step not |
| | gravity vector | to within 5 degrees | required) | required) |
| 2 | Stabilize system using | Surface can be at any | (Achieved in 1 | YES (step |
| | stabilization legs | inclination | above) | required) |
| 3 | Select reference points | | YES (step | YES (step |
| | | | required) | required) |
| 4 | Measure reference | | YES (step | YES (step |
| | points | | required) | required) |
| 5 | Determine Heading | | YES (step | YES (step |
| | angle of system | | required) | required) |
| 6 | Detect system | | Hardware | YES (step |
| | orientation with respect | | not | required) |
| | to local gravity vector | | available | |
| 7 | Apply algorithm to geo- | | YES, OLD | YES, NEW |
| | reference | | VERSION | VERSION |

Problems with the prior art system include the following:
a) The surface on which the radar is deployed must be level to a certain degree. If not, the leveling legs might not have sufficient travel to make the necessary level adjustments.
b) It is time consuming to make the level adjustments with sufficient accuracy.
c) There is no real-time indication of whether the radar remains stable during scanning.

The invention aims to overcome the problems of the known system and method of deployment. Using the system of the invention, the surface on which the radar system is deployed (the deployment surface) can have any gradient, in any direction, on which it is physically possible to deploy the system and does not have to be carefully selected to be flat and level. Once the radar system has been brought to the desired location, the stabilizing legs are lowered to stabilize the system on the deployment surface. The stabilizing legs will always have sufficient travel for deployment, since it is not necessary to level the radar.

The system is then switched on and operated in a set-up mode (see FIG. 4). The orientation of the radar system, with respect to the local gravity vector, is measured by the inclinometer 28 installed on the radar. The orientation reading is integrated electronically into the system by the System Data Processing module 34.

Next, the Total Station 44 is deployed for measurements of the reference points, measured in the following sequence:
1) The reference points A on or near the pit wall as indicated in FIG. 1 are measured;
2) The coordinates of the reference points above (in the Master Coordinate system) are entered into the System Data Processing module;
3) The reference points B on the radar as indicated in FIG. 1 are measured.

The measurements from the Total Station are uploaded to the System Data Processing module 34.

The system data processing module uses the readings from the inclinometer, the Total Station and other system data to do a final calculation of the radar orientation and position in the Instrument Coordinate System (ICS) with respect to the Master Coordinate system (MCS) by carrying out the following steps:
1) The origin of the Total Station in the Master Coordinate System (MCS) is determined using the measurements of the reference points A on or near the pit wall and the coordinates of the reference points in the MCS Coordinate system.
2) The origin of the Instrument Coordinate system (ICS) in the Master Coordinate System (MCS) is determined using the measured reference points B on the radar, and system parameters.
3) The orientation of the Instrument Coordinate System (ICS) with respect to the Master Coordinate System (MCS) is determined using the measured reference points B on the radar, and the above-mentioned orientation reading of the inclinometer.
4) The measurements of the reference points B on the radar are used to verify the health of the orientation reading of the inclinometer and can serve as a back-up in case of a malfunctioning of the inclinometer. Using three reference points on the radar, the Total Station can thus serve as a back-up instrument for the inclinometer.

A new geo-referencing algorithm is built from the steps 1 to 4 above and includes the error detection and back-up options mentioned in step 4.

Further points to emphasize:
1) The readings of the total station are integrated electronically once the user has completed the survey.
2) The readings of the Total Station can be entered into the System Data Processing module manually once the user has completed the survey.

The geo-referencing of the radar system is now completed and all the measurements of the radar will now automatically be reported in the Master Coordinate System (MCS).

To complete the set-up process of the above described example embodiment of a ground-based interferometric radar, the following steps are carried out:

1) Set up the required scan areas
2) Set up scanning rates
3) Set up the required resolution of scanning
4) Set up the alarm thresholds

### 5) Initiate Scanning

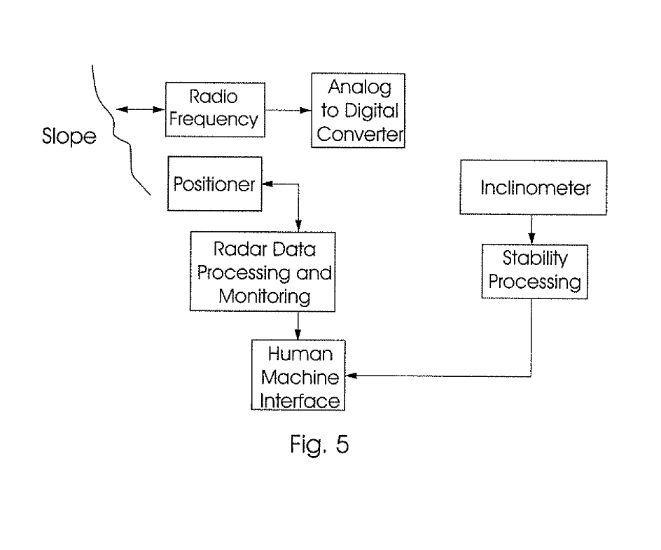

Once scanning has commenced the stability of the radar will be detected in real time and the system provides warnings if the radar is moving, as indicated in the processing block diagram of FIG. 5.

As mentioned above, the inclinometer 28 is a two-axis instrument, measuring two angles with respect to the local gravity vector. The orientation of the inclinometer with respect to the ICS has to be determined during manufacture of the radar system. In case of a field replacement of the inclinometer, the orientation of the replacement sensor has once again to be determined.

The orientation data of the inclinometer will be stored in the System Data Processing module 34 as parameters and will be used in conjunction with the measurements of the inclinometer to obtain the orientation of the ICS in relation to the MCS. This means two angles with respect to the local gravity vector as well as the heading angle of the radar (or other instrument). The necessary calculations for this are implemented in the block “Inclinometer Data Processing” in FIG. 4. The result of these calculations and the total station measurements will be utilized in the block “Geo-Referencing Algorithm”, FIG. 4. The result is a complete definition of the ICS with respect to the MCS, with 6 degrees of freedom (3 positions and 3 angles).

The described invention offers a number of useful features, including:
1) The option of deploying a radar system (or any other instrument using the described geo-referencing functionality) out of level with respect to the local gravity vector while still being geo-referenced to the Master Coordinate System (MCS), irrespective of the technologies used to achieve this; and
2) The real-time monitoring of the stability of the deployed system.

This will alert the user if the deployment site becomes unstable and as a result invalidates the measurements of the instrument.

The described invention has a number of advantages over known systems of the same general kind. These include:
Ease of deployment.
Reduced time required for deployment.
Improved accuracy and reliability.
Improved deployment options due to the fact that the gradient of the terrain is no longer a limitation when deciding on the deployment position of the system.
Real-time feedback on the stability of the instrument.

The last point, in particular, can result in improved safety in use. In the case of open pit mines where a radar is deployed to measure sub-millimeter movements on the pit wall for safety purposes, it is normally assumed that the instrument is deployed in a stable location. This assumption is not always correct. Because the described system is able to detect movement of the deployment site, a warning can be given if the deployment site becomes unstable, thereby eliminating safety risks associated with the assumption above.

Although an example embodiment of the invention in the form of a ground-based interferometric radar system has been described, the invention can be applied to other measuring instruments, for example a laser system requiring geo-referencing. The invention has particular application to equipment in open pit mines that needs to be geo-referenced to the Master Coordinate System of the mine, and includes visual monitoring of reference points for the purposes of geo-referencing without the prerequisite of being leveled.

Likewise, although a mobile trailer-mounted Interferometric radar system for slope stability monitoring has been described, the radar system could be mounted to a self-propelled vehicle, or alternatively be a fixed system.

### APPENDIX A

### Definitions

Geo-Referenced

The linking or referencing of an instrument to a master coordinate system.

Master Coordinate System (MCS)

A reference coordinate system in which a client wants data reported.

Instrument Coordinate System (ICS)

The coordinate system in which the instrument measures.

Leveled

This term means that a reference plane on the instrument is leveled with respect to the local horizon. This in turn means that this reference plane is perpendicular to the local gravity vector.

1. A method of geo-referencing a main measuring instrument which operates in an Instrument Coordinate System, the method including the steps of:
deploying the main measuring instrument on a deployment surface;
using an auxiliary measuring instrument, measuring the position of a plurality of external reference points in a Master Coordinate System;
using the auxiliary measuring instrument, measuring the position of a plurality of local reference points on the main measuring instrument in the Master Coordinate System;
using an inclinometer associated with the main measuring instrument, automatically obtaining an orientation reading for the deployed main measuring instrument;
entering the measured positions of the external reference points and the local reference points on the main measuring instrument into a processor of the main measuring instrument; and
using the orientation reading and the measured positions of the external reference points and the local reference points on the main measuring instrument, automatically geo-referencing the main measuring instrument so that measurements made therewith are automatically output in the Master Coordinate System.

2. A method according to claim 1 wherein the main measuring instrument is a radar or laser operable to monitor the stability of a slope, to detect slope movement and to generate an alert if movement is detected.

3. A method according to claim 2 wherein the main measuring instrument is a ground-based radar with an antenna mounted on a housing, the local reference points being on or adjacent the housing.

4. A method according to claim 3 wherein the inclinometer is mounted on a support member of the antenna which is fixed relative to the housing, the antenna being movable in azimuth and elevation relative to the support member.

5. A method according to claim 4 wherein the housing is mobile.

6. A method according to claim 3 wherein inputs are received from the antenna, and further inputs via a human/machine interface obtained from an auxiliary measuring instrument during a set-up phase of operation.

7. A measuring instrument system including:
a main measuring instrument which operates in an Instrument Coordinate System for monitoring at least one parameter of an environment in which it is deployed;
a support structure for deploying the main measuring instrument on a deployment surface;
an inclinometer associated with the main measuring instrument, for automatically obtaining an orientation reading for the deployed main measuring instrument;
a processor arranged to receive measured positions of a plurality of external reference points in a Master Coordinate System, measured positions of a plurality of local reference points on the measuring instrument in the Master Coordinate System, and an orientation reading from the inclinometer, and automatically to geo-reference the main measuring instrument so that measurements made therewith are automatically output in the Master Coordinate System; and
at least one output interface for outputting data representative of measurements made by the main measuring instrument.

8. A system according to claim 7 wherein the main measuring instrument is a radar or laser operable to monitor the stability of a slope, to detect slope movement and to generate an alert if movement is detected.

9. A system according to claim 8 wherein the main measuring instrument is a ground-based radar with an antenna mounted on a housing, the local reference points being on or adjacent the housing.

10. A system according to claim 9 wherein the inclinometer is mounted on a support member of the antenna which is fixed relative to the housing, the antenna being movable in azimuth and elevation relative to the support member.

11. A system according to claim 10 wherein the housing is mobile.

12. A system according to claim 7 wherein the processor is arranged to receive inputs from the antenna, and further inputs via a human/machine interface obtained from an auxiliary measuring instrument during a set-up phase of operation.
